(19) United States
(12) Patent Application Publication
(10) Pub. No.: US 2025/0347860 A1
(43) Pub. Date: Nov. 13, 2025

(54) SPRIT POLYMER OPTICAL WAVEGUIDE FOR HIGH DENSITY CO-PACKAGE INTEGRATION

(71) Applicant: International Business Machines Corporation, Armonk, NY (US)

(72) Inventors: Akihiro Horibe, Yokohama (JP); Yoichi Taira, Tokyo (JP); CHINAMI ISHIKAWA, Yokohama (JP)

(21) Appl. No.: 18/662,653

(22) Filed: May 13, 2024

(51) Int. Cl. G02B 6/40

(52) U.S. Cl. CPC G02B 6/403

(57) ABSTRACT

A device includes a photonics chip and a flexible waveguide having a first end connected to the photonics chip and a second end opposite the first end, in which the second end of the flexible waveguide includes a first portion connected to a ferrule module and a second portion connected to the ferrule module. The second portion is stacked vertically over the first portion in the ferrule module.

### BACKGROUND

The present invention relates generally to the flexible optical waveguides and, more particularly, to techniques for assembling with electronic and/or photonic components.

Low-cost, high throughput optical interconnects will become key technology to increase intra- and inter-system bandwidth requirements of data centers and high-performance computers. Integrating optics with computing hardware is challenging and limited by the size of silicon photonics chips (“PIC”) being connected to the optical interconnects.

### BRIEF SUMMARY

Principles of the invention provide techniques for integrating a single mode polymer optical waveguide (POW) technology and a scalable method for building the optical interface between PICs and the POW. In one aspect, an exemplary device includes a photonics chip and a flexible waveguide having a first end connected to the photonics chip and a second end opposite the first end in which the second end of the flexible waveguide includes a first portion connected to a ferrule module and a second portion connected to the ferrule module and wherein the second portion is stacked vertically over the first portion in the ferrule module.

Optionally, the second portion is folded over the first portion.

Optionally, the first portion is slid under the second portion.

Optionally, the ferrule module comprises one ferrule structure having two recesses accommodating the first portion and the second portion.

Optionally, the ferrule module comprises a first ferrule having one recess and a second ferrule having another recess wherein the second ferrule is stacked over the first ferrule.

In a further aspect of the invention, an exemplary device includes a photonics chip, a flexible waveguide ribbon having a first end connected to the photonics chip and a bifurcated second end opposite the first end wherein the bifurcated second end has a first portion 141 and a second portion stacked over the first portion, a first outer edge of the first portion 141 of the bifurcated second end, a second outer edge of the second portion of the bifurcated second end, a first inner edge of the first portion of the bifurcated second end, a second inner edge of the second portion of the bifurcated second end in which the second inner edge is over the first outer edge.

Optionally, the second outer edge is over the first inner edge.

Optionally, the device further includes a ferrule module connected to the second end.

Optionally, the ferrule module is a single structure having two recesses accommodating the first portion and the second portion.

Optionally, the ferrule module comprises a first ferrule having one recess connected to the first portion and a second ferrule having another recess connected to the second portion.

In another aspect of the invention, an exemplary device includes a photonics chip, a flexible waveguide ribbon having a first end connected to the photonics chip and second end which is bifurcated opposite the first end thereby creating a second end having a first portion and a second portion. The second portion is stacked over the first portion. The first portion second end having a first outer edge and the second portion having a second outer edge. The first portion of the second end having a first inner edge and the second portion having a second inner edge. The second inner edge being over the first inner edge.

Optionally, the second outer edge is over the first outer edge.

Optionally, the device further includes a ferrule module connected to the second end.

Optionally, the ferrule module is a one-ferrule structure with two recesses accommodating the first portion and the second portion.

Optionally, the ferrule module comprises a first ferrule having one recess connected to the first portion and a second ferrule having another recess connected to the second portion.

In yet another aspect of the invention, an exemplary flexible waveguide ribbon includes a first end, a second end which is bifurcated and opposite the first end, a cladding layer, and a plurality of waveguide cores surrounded by the cladding layer.

Optionally, the cladding layer is a polymer.

Optionally, the flexible optical waveguide ribbon can have at least 24 waveguide cores.

Optionally, the first end of the flexible waveguide ribbon lacks the cladding layer on a lower surface of the waveguide cores.

Optionally, the flexible optical waveguide ribbon has an inner edge having a length and a recessed ferrule having a recess width and attached to the second end the flexible optical waveguide ribbon, in which the inner edge length is greater than twice the recess width.

In yet another aspect of the invention, a ferrule module includes a first ferrule structure including an entrance side having a first recess to receive a first portion of a flexible optical waveguide ribbon and an exit side having a first plurality of core holes arranged in a row.

Optionally, the ferrule module also includes a second ferrule having a second entrance side with a second recess to receive a second portion of the flexible optical waveguide ribbon and a second exit side having a second plurality of core holes arranged in another row. The second ferrule being stacked over the first ferrule.

Optionally, the first exit side has at least 12 core holes and the second exit side has at least 12 core holes. A technical benefit increasing the density of waveguide cores can be connected to the photonics chip relative to conventional devices.

Optionally, the first ferrule further includes a second recess to receive a second portion of the flexible optical waveguide ribbon and the exit side has a second plurality of core holes arranged in a row under the first plurality of core holes.

Optionally, at least 12 core holes are in each of the first plurality of core holes and second plurality of core holes.

As used herein, “facilitating” an action includes performing the action, making the action easier, helping to carry the action out, or causing the action to be performed. Thus, by way of example and not limitation, instructions executing on a processor might facilitate an action carried out by optoelectronic circuit fabrication equipment or the like, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects, as will be discussed further below. Features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIGS. 1A-1C depict an exemplary flexible optical waveguide ribbon prior to sliding and after sliding and attaching to a chip and ferrule according to aspects of the invention;

FIGS. 2A-2B depict an exemplary flexible optical waveguide ribbon prior to folding and after folding and attaching to a chip and ferrule according to aspects of the invention; and

FIGS. 3A-3C depict exemplary ferrule module views according to aspects of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Aspects of invention provide for a flexible optical waveguide and, more particularly, to techniques for integrating the waveguide with electronic and/or photonic components.

In one aspect, an exemplary device 105 includes a photonics chip 170 and a flexible waveguide 100 having a first end 131 connected to the photonics chip170 and a second end 132 opposite the first end in which the second end 132 of the flexible waveguide 100 includes a first portion 141 connected to a ferrule module 180 and a second portion 142 connected to the ferrule module 180 and wherein the second portion 142 is stacked vertically over the first portion 141 in the ferrule module 180. A technical benefit of the device is that higher density of waveguide cores 110 can be connected to the photonics chip 170 relative to conventional devices.

Optionally, the second portion 142 is folded over the first portion 141. A technical benefit of the device is that higher density of waveguide cores 110 can be connected to the photonics chip 170 relative to conventional devices while potentially reducing the number of ferrules.

Optionally, the first portion 141 is slid under the second portion 142. A technical benefit of the device is that higher density of waveguide cores 110 can be connected to the photonics chip 170 relative to conventional devices while reducing the bending stress of the waveguide.

Optionally, the ferrule module 180 comprises one ferrule structure having two recesses 360 accommodating the first portion 141 and the second portion 142. A technical benefit of the device is that higher density of waveguide cores 110 can be connected to the photonics chip 170 relative to conventional devices while potentially reducing the number of ferrules and ferrule connecting steps.

Optionally, the ferrule module 180 comprises a first ferrule having one recess 360 and a second ferrule having another recess 300 wherein the second ferrule is stacked over the first ferrule. A technical benefit of the device is that higher density of waveguide cores 110 can be connected to the photonics chip 170 relative to conventional devices while reducing the area of the ferrules in the X-Y plane.

In a further aspect of the invention, an exemplary device includes a photonics chip 170, a flexible waveguide ribbon 100 having a first end 131 connected to the photonics chip 170 and a bifurcated second end 132 opposite the first end 131 wherein the bifurcated second end 132 has a first portion 141 and a second portion 142 stacked over the first portion 141, a first outer edge 151 of the first portion 141 of the bifurcated second end 132, a second outer edge 152 of the second portion 142 of the bifurcated second end 132, a first inner edge 161 of the first portion 141 of the bifurcated second end 132, a second inner edge 162 of the second portion of the bifurcated second end 132 in which the second inner edge 162 is over the first outer edge 151. A technical benefit of the device is that higher density of waveguide cores 110 can be connected to the photonics chip 170 relative to conventional devices while reducing the bending stress of the waveguide.

Optionally, the second outer edge 152 is over the first inner edge 161.

Optionally, the device further includes a ferrule module 180 connected to the second end 132.

Optionally, the ferrule module is a single structure having two recesses 360 accommodating the first portion 141 and the second portion 142. A technical benefit of the device is that higher density of waveguide cores 110 can be connected to the photonics chip 170 relative to conventional devices while potentially reducing the number of ferrules and ferrule connecting steps.

Optionally, the ferrule module comprises a first ferrule having one recess 360 connected to the first portion 141 and a second ferrule having another recess 360 connected to the second portion 142. A technical benefit of the device is that higher density of waveguide cores 110 can be connected to the photonics chip 170 relative to conventional devices while reducing the area of the ferrules in the X-Y plane.

In another aspect of the invention, an exemplary device includes a photonics chip 170, a flexible waveguide ribbon 110 having a first end 131 connected to the photonics chip 170 and second end 132 which is bifurcated opposite the first end 141 thereby creating a second end 132 having a first portion 141 and a second portion 142. The second portion 142 is stacked over the first portion 141. The first portion 141 second end 132 having a first outer edge 151 and the second portion having a second outer edge 152. The first portion 141 of the second end 132 having a first inner edge 161 and the second portion 142 having a second inner edge 162. The second inner edge 162 being over the first inner edge 161. A technical benefit of the device is that higher density of waveguide cores 110 can be connected to the photonics chip 170 relative to conventional devices while potentially reducing the number of ferrules.

Optionally, the second outer edge 152 is over the first outer edge 151.

Optionally, the device further includes a ferrule module 180 connected to the second end 132.

Optionally, the ferrule module 180 is a one-ferrule structure with two recesses 360 accommodating the first portion 141 and the second portion 142. A technical benefit of the device is that higher density of waveguide cores 110 can be connected to the photonics chip 170 relative to conventional devices while potentially reducing the number of ferrules and ferrule connecting steps.

Optionally, the ferrule module 180 comprises a first ferrule having one recess 360 connected to the first portion141 and a second ferrule having another recess connected to the second portion 142. A technical benefit of the device is that higher density of waveguide cores 110 can be connected to the photonics chip 170 relative to conventional devices while reducing the area of the ferrules in the X-Y plane.

In yet another aspect of the invention, an exemplary flexible waveguide ribbon 100 includes a first end 131, a second end 132 which is bifurcated and opposite the first end 131, a cladding layer 120, and a plurality of waveguide cores 110 surrounded by the cladding layer 120. A technical benefit of the flexible waveguide ribbon 100 having a bifurcated end is it can be manipulated so that waveguide cores 110 can be stacked thereby increasing the density of waveguide cores 110 can be connected to the photonics chip 170 relative to conventional devices.

Optionally, the cladding layer is a polymer.

Optionally, the flexible optical waveguide ribbon 100 can have at least 24 waveguide cores 110. A technical benefit of the flexible waveguide ribbon 100 having a bifurcated end is it can be manipulated so that waveguide cores 110 can be stacked thereby increasing the density of waveguide cores 110 can be connected to the photonics chip 170 relative to conventional devices.

Optionally, the first end 131 of the flexible waveguide ribbon 100 lacks the cladding layer 120 on a lower surface of the waveguide cores 110. A technical benefit is the uncladded lower surface can be adiabatically connected to a photonics chip 170.

Optionally, the flexible optical waveguide ribbon 100 has an inner edge 161 having a length and a recessed ferrule having a recess width and attached to the second end the flexible optical waveguide ribbon, in which the inner edge length is greater than twice the recess width. The technical benefit is the reduction of bending angle of the flexible optical waveguides.

In yet another aspect of the invention, a ferrule module 180 includes a first ferrule structure 180-S including an entrance side 181 having a first recess 360 to receive a first portion 141 of a flexible optical waveguide ribbon 100 and an exit side 182 having a first plurality of core holes 310 arranged in a row.

Optionally, the ferrule module 180 also includes a second ferrule having a second entrance side with a second recess to receive a second portion 142 of the flexible optical waveguide ribbon 100 and a second exit side having a second plurality of core holes 210 arranged in another row. The second ferrule being stacked over the first ferrule. A technical benefit of the device is that higher density of waveguide cores 110 can be connected to the photonics chip 170 relative to conventional devices while reducing the area of the ferrules in the X-Y plane.

Optionally, the first exit side has at least 12 core holes 310 and the second exit side has at least 12 core holes 310. A technical benefit increasing the density of waveguide cores 110 can be connected to the photonics chip 170 relative to conventional devices.

Optionally, the first ferrule further includes a second recess to receive a second portion 142 of the flexible optical waveguide ribbon 100 and the exit side 182 has a second plurality of core holes arranged in a row under the first plurality of core holes. A technical benefit of the device is that higher density of waveguide cores 110 can be connected to the photonics chip 170 relative to conventional devices while potentially reducing the number of ferrules and ferrule connecting steps.

Optionally, at least 12 core holes 310 are in each of the first plurality of core holes and second plurality of core holes. A technical benefit increasing the density of waveguide cores 110 can be connected to the photonics chip 170 relative to conventional devices.

Techniques as disclosed herein can provide substantial beneficial technical effects. Some embodiments may not have these potential advantages and these potential advantages are not necessarily required of all embodiments. By way of example only and without limitation, one or more embodiments may provide one or more of allowing further scaling, bandwidth, density, power efficiency and lower cost for electro-optical integration.

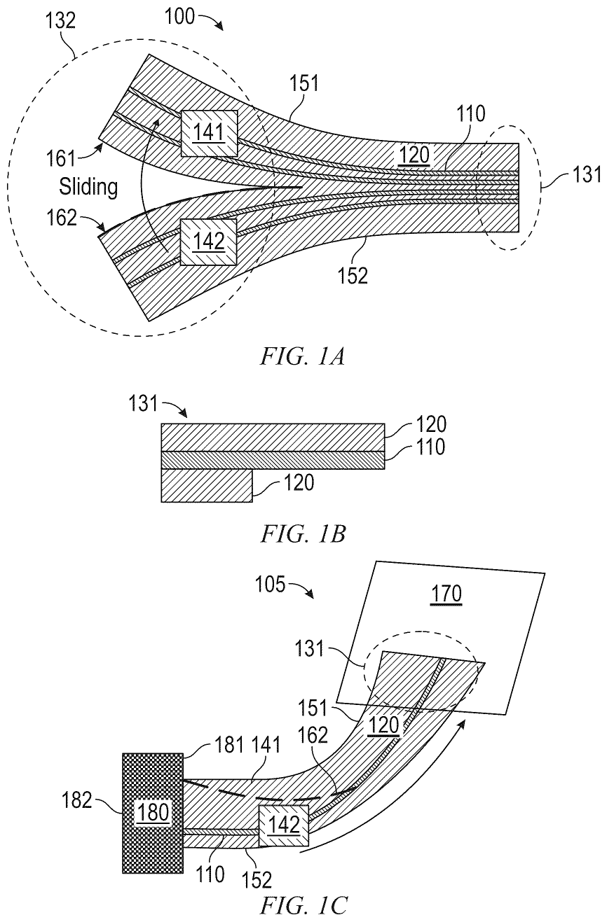

FIG. 1A depicts an exemplary flexible waveguide ribbon 100 in accordance with aspects of the invention. The flexible waveguide ribbon 100 includes a cladding layer 120 which surrounds a plurality of waveguide cores 110 which transmit optical signals. While the figure only depicts four cores, it is contemplated that many more waveguide cores 110 can be in the flexible waveguide ribbon 100. For example, 12, 24, 36 or more waveguide cores 110 are contemplated. The number of waveguide cores 110 is limited by the cross-talk requirement between neighboring cores. The flexible waveguide ribbon 100 has two opposite ends, namely a first end 131 and a second end 132. The second end 132 of the flexible waveguide ribbon 100 is separated to create different portions. In the example of FIG. 1A, the second end 132 is split in half. This bifurcated second end has a first portion 141 and a second portion 142 each containing waveguide cores 110. The flexible waveguide ribbon 100 has two outer edges along the length of the ribbon, namely the first outer edge 151 and the second outer edge 152. Because the second end 132 of the ribbon is separated into portions, inner edges are also present. Accordingly, in the example of FIG. 1A, the first portion 141 of the second end 132 is bounded by a first inner edge 161 and the first outer edge 151. Similarly, the second portion 142 of the second end 132 is bounded by a second inner edge 162 and the second outer edge 152. Each outer edge has an outer edge length and each inner edge has an inner edge length, where an inner edge length is no shorter than half of an outer edge length.

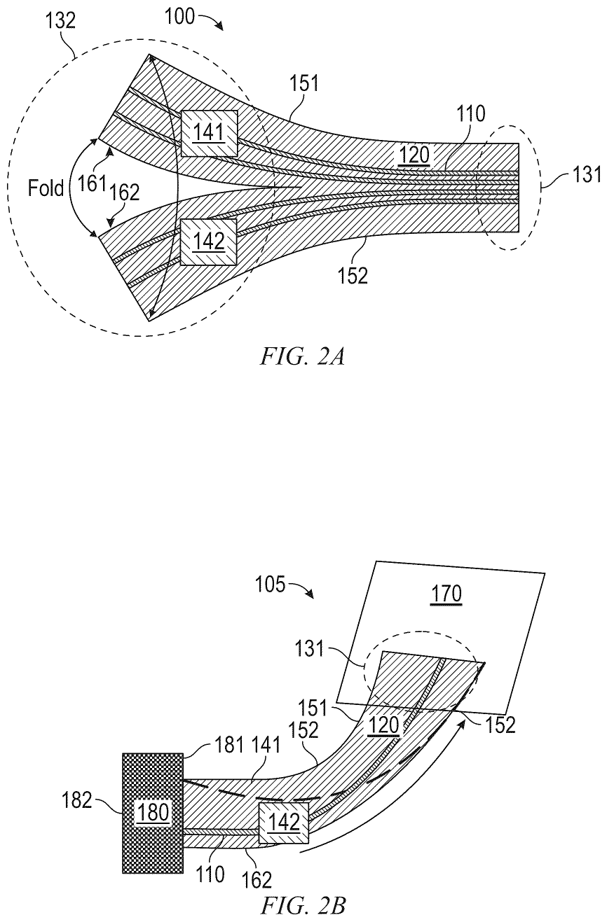

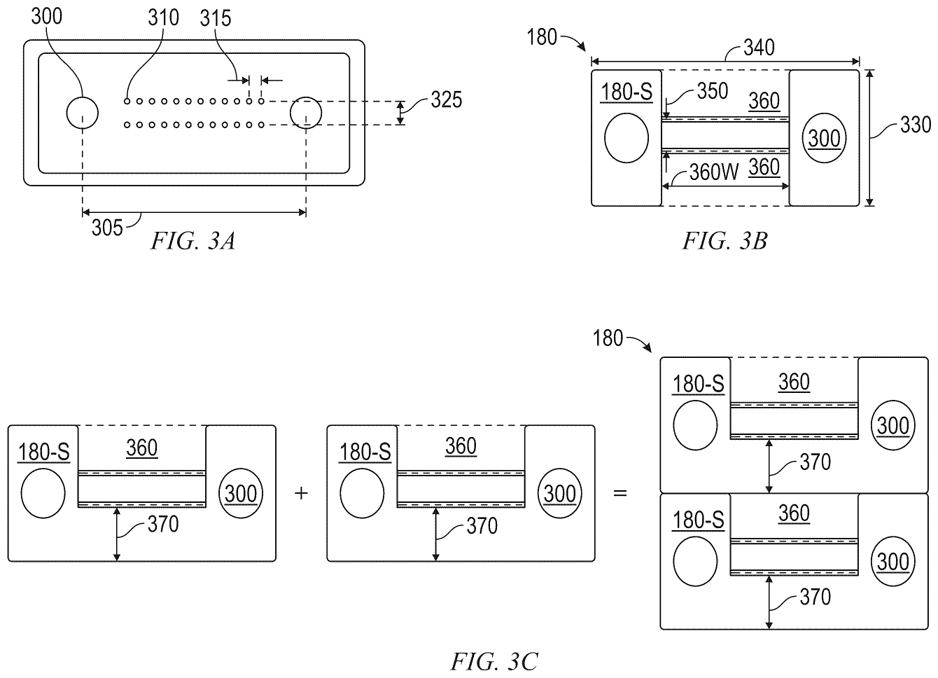

To integrate the flexible waveguide ribbon 100 to form a high density opto-electronic device, the first end 131 that will connect with an integrated circuit chip (e.g. a photonics chip 170 of FIG. 1C and FIG. 2B) while the second end 132 will connect to a ferrule module 180 (see FIG. 1C, FIG. 2B, and FIGS. 3A-3C). A first edge 131 on the photonic chip 170 side can have more than many waveguide cores 110. For simplicity, only four are drawn in the figure, but the invention contemplates at least 12 and more advantageously, 24 or more. In the example depicted in FIGS. 1A and 1C, integration occurs by sliding one portion of the second end 132 over the other portion of the second end 132 so the two ends are stacked over each other. As a result, the inner edge of one portion is over the outer edge of the other portion (e.g. second inner edge 162 of the second portion 142 is over first outer edge 151 of the first portion 141). Similarly, the other inner edge is under the other outer edge (e.g. first inner edge 161 of the first portion 141 is under the second outer edge 152 of the second portion 142). The two stacked portions are in a ferrule module 180. Also, as a result of the sliding the two portions over each other, the flexible waveguide ribbon 100 bends to create an angle (see arrow of FIG. 1C) which allows the first end 131 of the flexible waveguide ribbon 100 to make a flat connection at the flexible waveguide ribbon 100. FIG. 1B depicts the first end 131 of flexible waveguide ribbon 100 in which a portion of the cladding 120 is removed to expose a lower surface of the waveguide core 110 which can make an adiabatic coupling to the integrated circuit chip (e.g. photonics chip 170). Each of the cladding 120 and the waveguide core 110 can be a polymer having different refractive indices from each other. Advantageously, the waveguide core 110 polymer's refractive index is greater than the cladding 120 polymer's refractive index.

In the example depicted in FIGS. 2A and 2B, integration occurs by folding one portion of the second end 132 over the other portion of the second end 132 so the two ends are stacked over each other. As a result, the outer edge of one portion is over the outer edge of the other portion (e.g. second outer edge 152 of the second portion 142 is over first outer edge 151 of the first portion 141). Similarly, an inner edge is under the other inner edge (e.g. first inner edge 161 of the first portion 141 is under the second inner edge 162 of the second portion 142). The two stacked portions of the second end 132 are in a ferrule module 180. Also, as a result of the folding the two portions over each other, the flexible waveguide ribbon 100 bends to create an angle (see arrow of FIG. 2B) which allows the first end 131 of the flexible waveguide ribbon 100 to make a flat connection at the flexible waveguide ribbon 100. Similar to FIG. 1B, the first end 131 of the folded flexible waveguide ribbon 100 has a portion of the cladding 120 is removed to expose a lower surface of the waveguide core 110 which can make an adiabatic coupling to the integrated circuit chip (e.g. photonics chip 170).

Turning to the ferrule module 180, it has an entrance side 181 in which the first portion 141 and second portion 142 of the second end 132 of the flexible waveguide ribbon 100 is received. The ferrule module 180 also has an exit side 182 from which the waveguide cores 110 transmit. The ferrule module 180 can be composed of two single ferrule structures 180-S each having one recess 360 and each receiving one of the first portion 141 or the second portion 142 of the second end 132 of the flexible waveguide ribbon 100. In such cases, each single ferrule 180-S (see FIG. 3C depicting the entrance side 181) has a recess 360. Then the two single ferrule structures 180-S can be stacked on top of each other to form the ferrule module 180. Alternatively, referring to FIG. 3B, the ferrule module 180 can be composed of a single ferrule structure 180-S having two recesses 360. Each recess 360 accommodates one of the portions of the second end 132 of the flexible waveguide ribbon 100.

By way of example and not by limitation, the ferrule entrance side heigh 340 can be about 3 mm, a ferrule entrance side width can be about 7 mm, and a recess width 360w can be about 3.3 mm. Referring to FIG. 3B, by way of example and not by limitation, a ferrule bridge height 350 can be about 0.5 mm. Referring to FIG. 3C, by way of example and not by limitation, a ferrule base height 370 can be about 1.2 mm.

The ferrule exit side 182 is depicted in FIG. 3A. The ferrule exit side 182 has guide holes 300 for receiving alignment pins of a mating ferrule (not shown). By way of example and not by limitation, a ferrule module 180 accommodating 24 wavelength cores 110 can have a guide hole pitch 305 can be about 4.6 mm and a guide hole diameter can be about 0.70 mm. The same module also has two rows of core holes 310 through which optical signals can be transmitted. By way of example and not by limitation, a core hole horizontal pitch 315 can be about 0.25 mm and a core hole vertical pitch 325 can be about 0.50 mm. In another embodiment, again by way of example and not by limitation, a ferrule module 180 accommodating 32 wavelength cores 110 can have a guide hole pitch 305 can be about 5.3 mm and a guide hole diameter can be about 0.55 mm. The same module also can have two rows of core holes 310 through which optical signals can be transmitted. By way of example and not by limitation, a core hole horizontal pitch 315 can be about 0.25 mm and a core hole vertical pitch 325 can be about 0.50 mm.

Although the overall fabrication method and the structures formed thereby are novel, certain individual processing steps required to implement the method may utilize conventional fabrication techniques and/or tooling. These techniques and tooling will already be familiar to one having ordinary skill in the relevant arts given the teachings herein. It is emphasized that while some individual processing steps are set forth herein, those steps are merely illustrative, and one skilled in the art may be familiar with several equally suitable alternatives that would be applicable.

It is to be appreciated that the various elements shown in the accompanying figures may not be drawn to scale. Furthermore, one or more elements commonly used in optoelectronic devices may not be explicitly shown in a given figure for ease of explanation. This does not imply that the elements not explicitly shown are omitted in the actual device.

The illustrations of embodiments described herein are intended to provide a general understanding of the various embodiments, and they are not intended to serve as a complete description of all the elements and features of apparatus and systems that might make use of the circuits and techniques described herein. Many other embodiments will become apparent to those skilled in the art given the teachings herein; other embodiments are utilized and derived therefrom, such that structural and logical substitutions and changes can be made without departing from the scope of this disclosure. It should also be noted that, in some alternative implementations, some of the steps of the exemplary methods may occur out of the order noted in the figures. For example, two steps shown in succession may, in fact, be executed substantially concurrently, or certain steps may sometimes be executed in the reverse order, depending upon the functionality involved. The drawings are also merely representational and are not drawn to scale. Accordingly, the specification and drawings are to be regarded in an illustrative rather than a restrictive sense.

Embodiments are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Terms such as “bottom”, “top”, “above”, “over”, “under” and “below” are used to indicate relative positioning of elements or structures to each other as opposed to relative elevation. If a layer of a structure is described herein as “over” another layer, it will be understood that there may or may not be intermediate elements or layers between the two specified layers. If a layer is described as “directly on” another layer, direct contact of the two layers is indicated. As the term is used herein and in the appended claims, “about” means within plus or minus ten percent.

The corresponding structures, materials, acts, and equivalents of any means or step-plus-function elements in the claims below are intended to include any structure, material, or act for performing the function in combination with other claimed elements as specifically claimed. The description of the various embodiments has been presented for purposes of illustration and description, but is not intended to be exhaustive or limited to the forms disclosed. Many modifications and variations will be apparent to those of ordinary skill in the art without departing from the scope and spirit thereof. The embodiments were chosen and described in order to best explain principles and practical applications, and to enable others of ordinary skill in the art to understand the various embodiments with various modifications as are suited to the particular use contemplated.

The abstract is provided to comply with 37 C.F.R. § 1.76(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, the claimed subject matter may lie in less than all features of a single embodiment. Thus, the following claims are hereby incorporated into the Detailed Description, with each claim standing on its own as separately claimed subject matter.

Given the teachings provided herein, one of ordinary skill in the art will be able to contemplate other implementations and applications of the techniques and disclosed embodiments. Although illustrative embodiments have been described herein with reference to the accompanying drawings, it is to be understood that illustrative embodiments are not limited to those precise embodiments, and that various other changes and modifications are made therein by one skilled in the art without departing from the scope of the appended claims.

What is claimed is:

1. A device comprising:
a photonics chip; and
a flexible waveguide having a first end connected to the photonics chip and a second end opposite the first end;
wherein the second end of the flexible waveguide includes a first portion connected to a ferrule module and a second portion connected to the ferrule module and wherein the second portion is stacked vertically over the first portion in the ferrule module.

2. The device of claim 1, wherein the second portion is folded over the first portion.

3. The device of claim 1, wherein the first portion is slid under the second portion.

4. The device of claim 1, wherein the ferrule module comprises a single structure having two recesses accommodating the first portion and the second portion.

5. The device of claim 1, wherein the ferrule module comprises a first single ferrule structure having one recess and a second single ferrule structure having another recess, wherein the second single ferrule structure is stacked over the first single ferrule structure.

6. A device comprising:
a photonics chip;
a flexible waveguide ribbon having a first end connected to the photonics chip and a bifurcated second end opposite the first end wherein the bifurcated second end has a first portion and a second portion stacked over the first portion;
a first outer edge of the first portion of the bifurcated second end;
a second outer edge of the second portion of the bifurcated second end;
a first inner edge of the first portion of the bifurcated second end; and
a second inner edge of the second portion of the bifurcated second end;
wherein the second inner edge is over the first outer edge.

7. The device of claim 6, wherein the second outer edge is over the first inner edge.

8. The device of claim 6, further comprising a ferrule module connected to the second end.

9. The device of claim 8, wherein the ferrule module comprises a single ferrule accommodating both the first portion and the second portion.

10. The device of claim 8, wherein the ferrule module comprises a first ferrule connected to the first portion and a second ferrule connected to the second portion.

11. A device comprising:
a photonics chip;
a flexible waveguide ribbon having a first end connected to the photonics chip and a bifurcated second end opposite the first end wherein the bifurcated second end has a first portion and a second portion stacked over the first portion;
a first outer edge of the first portion of the bifurcated second end;
a second outer edge of the second portion of the bifurcated second end;
a first inner edge of the first portion of the bifurcated second end; and
a second inner edge of the first portion of the bifurcated second end;
wherein the second inner edge is over the first inner edge.

12. The device of claim 11, wherein the second outer edge is over the first outer edge.

13. The device of claim 11, further comprising a ferrule module connected to the second end.

14. The device of claim 13, wherein the ferrule module comprises a single ferrule accommodating both the first portion and the second portion.

15. The device of claim 13, wherein the ferrule module comprises a first ferrule connected to the first portion and a second ferrule connected to the second portion.

16. A flexible waveguide ribbon comprising:
a first end;
a bifurcated second end opposite the first end;
a cladding layer; and
a plurality of waveguide cores surrounded by the cladding layer.

17. The flexible optical waveguide ribbon of claim 16, wherein the cladding layer is a polymer.

18. The flexible optical waveguide ribbon of claim 16, having at least 24 waveguide cores.

19. The flexible optical waveguide ribbon of claim 16, wherein the first end lacks the cladding layer on a lower surface of the waveguide cores.

20. The flexible optical waveguide ribbon of claim 16, further comprising:
an inner edge have an inner edge length, and
a recessed ferrule having a recess width and attached to the second end;
wherein the wherein the inner edge length is greater than twice the recess width.

21. A ferrule module comprising:
a first ferrule comprising:
an entrance side having a first recess to receive a first portion of a flexible optical waveguide ribbon; and
an exit side having a first plurality of core holes arranged in a row.

22. The ferrule module of claim 21 further comprising:
a second ferrule comprising:
a second entrance side having a second recess to receive a second portion of the flexible optical waveguide ribbon; and
a second exit side having a second plurality of core holes arranged in a row;
wherein the second ferrule is stacked over the first ferrule.

23. The ferrule module of claim 22 wherein the first exit side has at least 12 core holes and the second exit side has at least 12 core holes.

24. The ferrule module of claim 21 wherein the first ferrule further comprises a second recess to receive a second portion of the flexible optical waveguide ribbon, and wherein the exit side has a second plurality of core holes arranged in a row under the first plurality of core holes.

25. The ferrule module of claim 24 wherein at least 12 core holes are in each of the first plurality of core holes and second plurality of core holes.
